(19) United States
(12) Patent Application Publication
(10) Pub. No.: US 2020/0383514 A1
(43) Pub. Date: Dec. 10, 2020

(54) APPARATUS AND METHOD FOR PREPARING A BEVERAGE

(71) Applicant: Viktor Kaptelinin, Hornefors (SE)

(72) Inventor: Viktor Kaptelinin, Hornefors (SE)

(21) Appl. No.: 16/892,841

(22) Filed: Jun. 4, 2020

Related U.S. Application Data
(60) Provisional application No. 62/857,140, filed on Jun. 4, 2019.

(51) Int. Cl. A47J 31/20; A47J 31/06; A47J 31/44

(52) U.S. Cl. CPC A47J 31/20; A47J 31/0615; A47J 31/4407; A47J 31/4482; A47J 31/0636

(57) ABSTRACT

An apparatus is provided for making beverages by immersing an infusible material, such as loose tea-leaves, in a liquid, such as hot water. The apparatus comprises two rigid-frame containers, a liquid-impermeable open-top beverage container, which can be an existing container selected by the user, and a movable liquid-permeable infuser container. According to embodiments of the invention, the infuser container may assume two different stationary positions relative to the beverage container, a lower stationary position and a higher stationary position. In the lower stationary position, the infusible material is covered by liquid and may be infused for a desired length of time. Thereafter the infuser container may be temporarily placed in the higher stationary position, in which position the infusible material is located above the liquid, to reduce or stop the dripping of the infusible material.

### CROSS-REFERENCE TO RELATED APPLICATIONS

The present application claims the benefit of provisional U.S. Patent Application Ser. No. 62/857,140, filed Jun. 4, 2019 with title “APPARATUS FOR PREPARING A BEVERAGE” and naming Viktor Kaptelinin as inventor.

### FEDERALLY SPONSORED RESEARCH

Not Applicable

### FIELD

The invention generally relates to the field of making a beverage, such as tea, herbal tea, or coffee, by infusing contents, such as tea-leaves, herbs, or ground coffee beans, in liquids. More specifically, it relates to beverage making devices comprising infusers or filters being immersed in liquids.

### BACKGROUND

A common way of making beverages, such as tea or coffee, is infusing an infusible material in liquid. The infusion process may be also referred to as “steeping”, “extracting”, or “brewing”. Infusible materials commonly used for making beverages include dried tea-leaves, herbs, dried berries, ground coffee, and so forth. The most commonly used liquid is hot water, but other liquids, such as milk, can also be used.

One type of infuser devices, known in prior art, are devices that comprise two essential parts, a stationary open top beverage container and a movable infuser container. Additional parts, such as lids, handles, nozzles, and so forth, may be added for convenience, safety, efficiency, or decorative purposes, but such additional parts are not absolutely necessary for the devices to serve their function.

The beverage container is made of watertight, water-impermeable material, such as glass, metal, plastic, porcelain, clay, and the like, so that the beverage container can contain a liquid, such as hot water. The beverage container often has a flat bottom, which enables the beverage container to stand upright on a horizontal surface. The beverage container has an opening at the top. The infuser container is constructed to be capable of containing infusible materials, such as loose tea-leaves, inside the infuser container. The infuser container is at least partly liquid-permeable, which permeability is achieved, for instance, by using perforation holes or employing liquid-permeable materials, such as mesh or fabrics. Therefore, while infusible materials are contained within the insert container, the liquid used for making a beverage can flow or trickle in and out of the insert container.

Two examples of prior art illustrating the structure and use of beverage making devices (apparatuses), implemented as two-container infuser devices described above, are shown in FIGS. 1-2. FIG. 1a and FIG. 1b show beverage container 10 implemented as an open top cylinder made of glass, with closed bottom 11 and top opening 12. Infuser container 15, also implemented as an open top cylinder made of glass, has bottom 16 with small perforation holes 17, top opening 18, and flange 19. When infuser container 15 is fully inserted in beverage container 10, infuser container 15 assumes a stable stationary position sitting on, and supported by, beverage container 10.

FIG. 2 shows another example of a two-container infuser device. Beverage container 25 is made of porcelain and has the shape of a conventional teapot having nozzle 26 and handle 27. The walls of rigid-frame infuser container 28 are made mostly of metal mesh. Otherwise the beverage-making device shown in FIG. 2 is similar in its function and method of use to the beverage-making device depicted in FIG. 1.

Two-part infuser devices comprising an easily detachable rigid-frame infuser container have a number of advantages. They are easier to manufacture, learn, operate, and clean than more complex devices, such as devices comprising a suspended infuser container that moves up and down inside a beverage container. However, a disadvantage of existing infuser devices of the two-part type is that they may not provide a good solution to the problem of a prolonged dripping of the infusible material. In the process of the infusion the infusible material absorbs liquid, which liquid often drips from the infuser container for a relatively prolonged period of time after the infuser container is removed from the beverage container. The user faces the dilemma of either (a) manually holding the infuser container over the beverage container and waiting for the dripping to end, and thus wasting their time, or (b) removing the infuser container while the liquid is still dripping, and thus causing stains and wasting potentially valuable beverage.

Therefore, a limitation of prior art is that prior art does not teach beverage-making infusing devices, which are effective, safe, and easy to operate and clean, and which, at the same time, offer a solution to the problem of a prolonged dripping of infusible material.

### SUMMARY OF THE INVENTION

An infuser-type apparatus for preparing beverages is provided, with the aim of helping the user to deal with the problem of a prolonged dripping of an infusible material, which dripping takes place after the used infusible material is removed from liquid. The apparatus comprises a stationary open-top liquid-impermeable beverage container and a movable infuser container. Each of the containers comprises a bottom and walls. The detachable infuser container is being liquid-permeable whereas impermeable to the infusible material. The infuser container can be substantially directly inserted to the beverage container, or removed from the beverage container, through a top opening of the beverage container. The user can differently spatially orient the infuser container, for instance, by manually manipulating the container.

The beverage container and the infuser container are configured to permit the infuser container, when the infuser container is received within the beverage container, to assume one of two stationary positions relative to the beverage container, a lower stationary position and a higher stationary position. In the lower stationary position the infuser container is inserted more in the beverage container than it is in the higher stationary position. The particular position assumed by the infuser container, that is, the lower stationary position or the higher stationary position, is determined by the spatial orientation of the infuser container relative to the beverage container when the infuser container is being received within the beverage container. When the infuser container has one of a first plurality of spatial orientations relative to the beverage container when being moved downwards to the beverage container (lowered on the beverage container), the infuser container takes the lower stationary position. When the infuser container has one of a second plurality of spatial orientations relative the beverage container when being moved downwards toward the beverage container, the infuser container assumes the higher stationary position. In each of the stationary positions the infuser container rests on the beverage container and is stably supported by the beverage container.

According to different embodiments of the invention, changing the orientation of the infuser container from one out of said first plurality of orientations to one out of said second plurality of orientations is performed by a user-action selected from a group comprising: (a) rotating the infuser container about its central vertical longitudinal axis, (b) tilting the infuser container by rotating the infuser container about a horizontal axis, and (c) moving the vertically oriented infuser container horizontally.

According to the first embodiment of the invention, a transition from one of the first plurality of orientations to one of the second plurality of orientations is achieved by rotating the infuser container about its central longitudinal axis. The beverage container and the infuser container are adapted to permit a section of the beverage container to receive a section of the infuser container if the infuser container is in one of the first plurality of orientations, and not permit said section of the beverage container to receive said section of the infuser container if the infuser container is in one of the second plurality of orientations. Consequently, in one of the first plurality of orientations the infuser container is capable of being inserted in the beverage container for a longer distance (and assuming a lower stationary position) than in one of the second plurality of orientations (and assuming a second higher stationary position).

According to the second embodiment of the invention, a transition from one of the first plurality of orientations to one of the second plurality of orientations is, like in the case of the first embodiment, also achieved by rotating the infuser container about a central longitudinal axis. The infuser container according to the second embodiment comprises a plurality of extension elements being connected to a top part of the infuser container and extending downward outside the beverage container, substantially along external walls of the beverage container. The external walls of the beverage container comprise at least a first plurality of matching externally protruding elements.

In each of the first plurality of orientations of the infuser container the extension elements are not vertically aligned with matching protruding elements.

Therefore, when the infuser container is being downwardly inserted in the beverage container, the extension elements move down unobstructed. In each of the second plurality of orientations of the infuser container the extension elements are vertically aligned with the matching protruding elements. Therefore, when the infuser container is being downwardly inserted in the beverage container, the extension elements contact the protrusion elements and meet resistance from the protrusion elements. Consequently, the distance, for which the infuser container having one out of the first plurality of orientations can be inserted through the top opening of the beverage container before assuming a first stationary position is longer that the distance for which the infuser container having one out of the second plurality of orientations can be inserted through the top opening of the beverage container before assuming a second stationary position.

According to the third embodiment of the invention, one of the first plurality of orientations is transformed into one of the second plurality of orientations by tilting the infuser container, that is, rotating the infuser container about a horizontal axis. The beverage container and the infuser container are configured so that in one of the first plurality of orientations the infuser container is inserted vertically through the top opening of the beverage container and assumes the lower stationary position. A multitude of supporting means is provided to support the infuser container having one of the second plurality of orientations in a tilted elevated higher stationary position, in which higher stationary position the infuser container rests on the beverage container and is supported by said beverage container.

According to the fourth embodiment of the invention, one of the first plurality of orientations is transformed into one of the second plurality of orientations by horizontally moving the infuser container, the infuser container being in the upright position, relative to the beverage container. The apparatus according to the fourth embodiment comprises, in addition to the beverage container, a separate secondary vertically oriented open-top section. The secondary section has a bottom, which is located higher than the bottom of the beverage container.

The secondary section is connected to the main beverage container with a through channel to permit the liquid to flow from the secondary section to the beverage container. The secondary section and the insert container are configured to permit an insertion of the insert container through an opening at the top part of the secondary section. In the first plurality of orientations the infuser container is vertically aligned with the opening of the beverage container, and, when moved downwards, is inserted in the beverage container and assumes a lower stationary position. In the second plurality of orientations the infuser container is vertically aligned with the top opening of the secondary section and, when moved downwards, is inserted in the secondary section and assumes a higher stationary position.

### DRAWINGS

FIG. 1-2: prior art.

FIG. 3-21: embodiments of the present invention

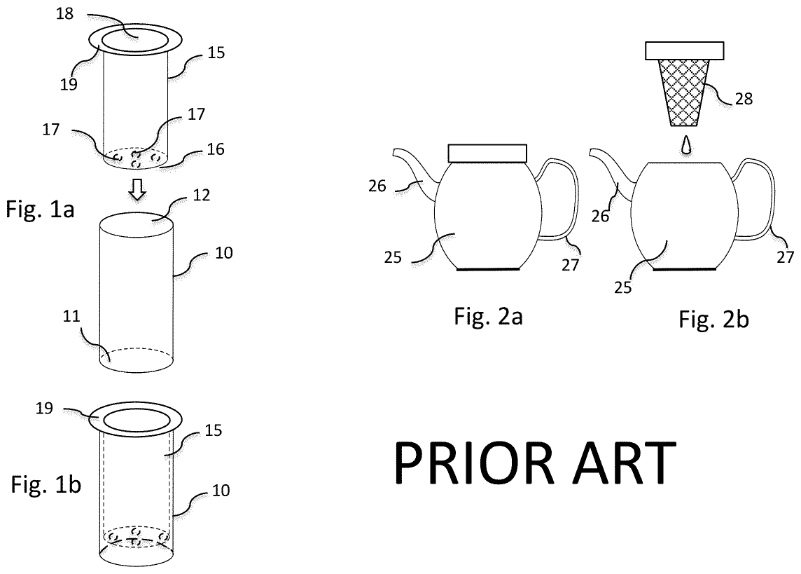

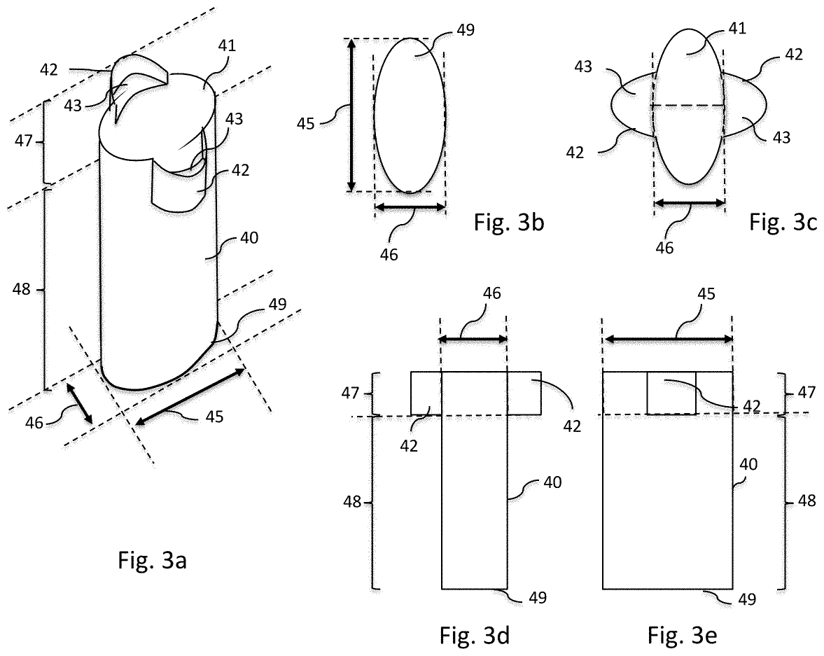

### DETAILED DESCRIPTION OF THE INVENTION

### General Remarks

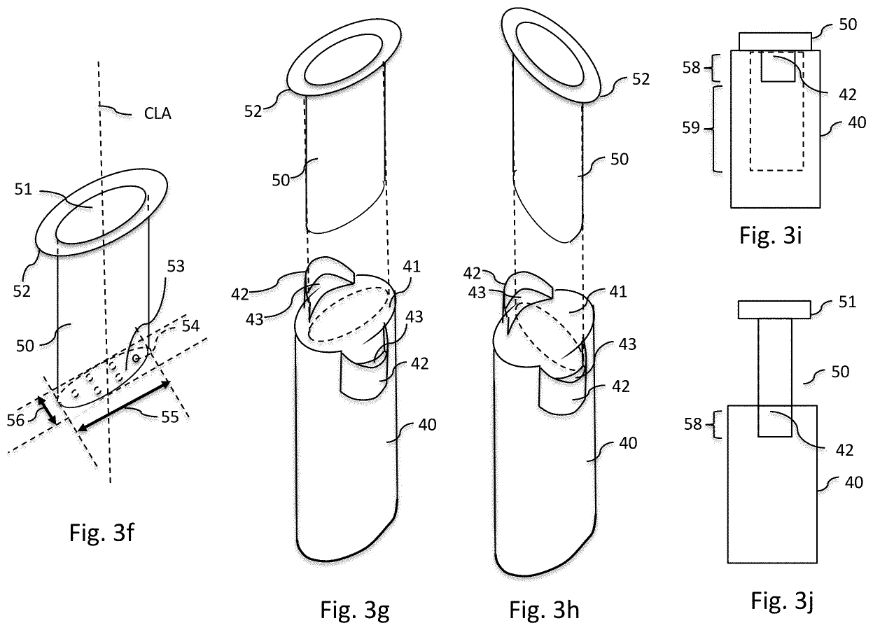

FIGS. 3-18 illustrate four preferred embodiments of the invention. Each embodiment is related to making beverages by immersing an infusible material in a liquid. The infusible material used to prepare a beverage, may include, for instance, tea-leaves, ground coffee beans, or various herbs and berries. The liquid used the preparation of a beverage may be, for instance, hot water, cold water, hot milk, alcohol solution, and so forth.

Each of the embodiments illustrated by FIG. 3-18 comprises at least two containers. The first container is a liquid-impermeable beverage container, in which the desired beverage is prepared. The beverage container is a vessel, in which the infusible material, used in making the beverage, is immersed in a liquid to produce the beverage. The beverage container is substantially stationary: the user may not need to move the container when preparing the beverage. The container comprises a body, which body comprises a bottom, walls, and a top opening. The container has a rigid frame made of a hard material, and may be completely made of a hard material. Therefore, the container is capable of substantially keeping its shape under normal use conditions. When in use, the beverage container is typically in an upright position.

The second container is a detachable and movable infuser container, which may be inserted in beverage container through the top opening of the beverage container. The infuser container contains the infusible material. The container comprises a body, which body comprises a bottom, walls, and a top opening (said top opening may be covered with an optional lid). The container has a rigid frame made of a hard material, and may be completely made of a hard material. Therefore, the container is capable of substantially keeping its shape under normal use conditions. The infuser container is impermeable to the infusible material: the construction of the infuser container prevents the infusible material from passing through the body of the infuser container. At the same time, at least a part of the body of the infuser container is adapted to be liquid-permeable, so that the liquid can pass through the body of the infuser container. The infuser containers may be configured to be liquid-permeable but impermeable to the infusible material by, for instance, providing small perforation holes, or employing metal mesh, plastic mesh, or fabrics in the construction of the container.

According to the embodiments described in FIGS. 3-18, the infuser container can be directly placed on the beverage container by simply moving the infuser container downwards. When being moved in such a manner, the infuser container assumes a stationary position, in which position the infuser container is resting/sitting on the beverage container and being supported by the beverage container. In accordance with the present invention the infuser container can be placed in one of two different stationary positions, a lower stationary position, and a second higher stationary position. In the lower stationary position the infuser container sits/rests on the beverage container and is at least partly inserted in the beverage container. In the higher stationary position the infuser container is inserted less, or not inserted at all, in the beverage container, and the bottom of the infuser container is located higher than said bottom is located the lower stationary position. In each of these stationary positions the apparatus is stable under normal use conditions (e.g., the apparatus is placed on a substantially horizontal stable surface and the user does not apply excessive force when inserting the infuser container into the beverage container). Therefore, when the infuser container assumes one of these two stationary positions, the whole apparatus is in a stable position and does not require user-actions to maintain a stable position.

According to the embodiments shown in FIG. 3-FIG. 18, said beverage container and said infuser container are configured to permit an infuser container having one out of a first plurality of spatial orientations relative to said beverage container, when the infuser container is being placed on the beverage container, to assume said lower stationary position. According to the embodiments shown in FIG. 3-FIG. 18, in the first plurality of spatial orientations said top opening of said infuser container is being located above said bottom of said infuser container, and said bottom of said infuser container and said opening of said beverage container are substantially vertically aligned with each other. Said beverage container and said infuser container are also configured to permit an infuser container having one out of a second plurality of spatial orientations relative to said beverage container, when the infuser container is being placed on the beverage container, to assume said higher stationary position.

Therefore, the user, when mounting an infuser container on a beverage container by moving said infuser container downwards toward the beverage container, may selectively cause the infuser container to assume the lower stationary position or the higher stationary position by selecting, respectively, one out of the first plurality of orientations or one out of the second plurality of orientations of the infuser container relative to the beverage container. In the lower stationary position an infusible material may be immersed in a liquid, and in the higher stationary position the infusible content may be elevated above the liquid.

### First Embodiment—Description (FIG. 3)

FIG. 3 shows a device according to the first embodiment of the present invention. The device comprises beverage container 40, and infuser container 50. For simplicity, the walls of the containers are assumed to be thin; the walls are represented by single lines.

The liquid-impermeable open-top beverage container 40 (FIG. 3a-FIG. 3e) comprises two integrated sections: a lower section 48 and a higher section 47. Lower section 48 has an elliptical shape in a horizontal cross-section. An inside perimeter of a horizontal cross-section of lower section 48 is an ellipse having a major axis 45 and a minor axis 45 (FIG. 3b). Higher section 47 continues lower section 48 upwards and defines top opening 41. The wall of higher section 47 comprises two oppositely located recesses 42, which recesses protrude outwardly from, respectively, the front side and the back side of beverage container 40. Bottom parts of recesses 42 form ledges 43. Lower section 48 and higher section 47, comprising recesses 42, are connected to each other to make sure that the entire body of beverage container 40 is liquid-impermeable (e.g., watertight).

FIG. 3c shows a top view of opening 41. The shape of opening 41 is defined by a central orthogonal intersection of two equal ellipses, one of the ellipses being a horizontal cross-section of lower section 48 and the other ellipse being an ellipse defined by recesses 42. FIG. 3d and FIG. 3e show, respectively, a side view and a front view of beverage container 40.

Infuser container 50 (FIG. 3f) is an open-top container having top opening 51, bottom 53, and perforation holes 54. Annular flange 52 projects radially outwards from opening 51. The body of infuser container 50 has an elliptical shape in a horizontal cross section. The inside perimeter of a horizontal cross-section of container 50 has the shape of an ellipse having major axis 55 and minor axis 56.

The length of major axis 45 of beverage container 40 is greater than the length of major axis 55 of infuser container 50, and the length of minor axis 46 of beverage container 40 is greater than the length of minor axis 56 of infuser container 50, whereas the length of minor axis 46 of beverage container 40 is smaller than the length of major axis 55 of infuser container 50. Consequently, when infuser container 50 is rotated about its central longitudinal axis CLA so that major axis 45 is aligned with major axis 55, and minor axis 46 is aligned with minor axis 56, the outside perimeter of infuser container 50 is completely within the inside perimeters of both higher section 47 and lower section 48. When infuser container 50, in this first orientation, is lowered toward beverage container 40, infuser container 50 is inserted in both section 47 and section 48 of beverage container 40 (FIG. 3g). When infuser container 50 is substantially completely inserted in beverage container 40, flange 52 of infuser container 50 rests on the rim of opening 41, and infuser container 50 assumes a substantially stable lower stationary position (FIG. 3i).

However, when infuser container 50 is rotated about its central longitudinal axis CLA so that major axis 55 of the infuser container is aligned with minor axis 46 of the beverage container, the outside perimeter of infuser container 50 is completely within the inside perimeter of higher section 47, but not within the inside perimeter of lower section 48 (FIG. 3h). Therefore, infuser container 50 cannot be inserted into lower section 48 of beverage container 40. When infuser container 50, in this second orientation, is moved down toward beverage container 40, infuser container 50 is inserted in higher section 47 but not in lower section 48. Being received within higher section 47 infuser container 50 occupies the space defined by recesses 42 and rests on ledges 43, which ledges provide support for bottom 53. When inserted into recesses 42, infuser container 50 assumes a substantially stable higher stationary position (FIG. 3j).

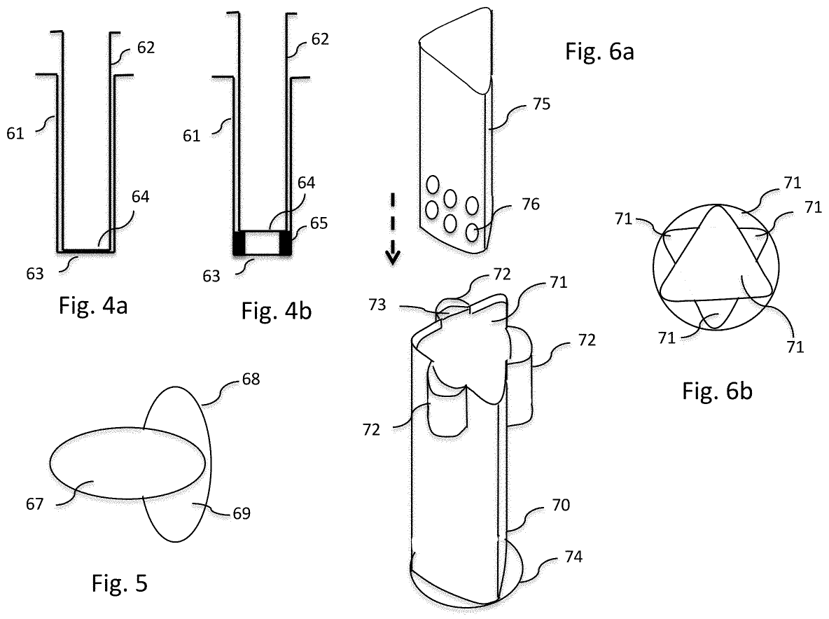

The illustrations of the first embodiment presented in FIG. 4 show a first orientation of infuser container 50, which results in the lower stationary position of infuser container 50 (FIG. 3g, FIG. 3i) and a second orientation of infuser container 50, which results in the higher stationary position of infuser container 50 (FIG. 3h, FIG. 3j). However, the lower stationary position of infuser container 50 may result from several functionally identical orientations of infuser container 50. If infuser container 50 shown in FIG. 3g is rotated about central longitudinal axis CLA (FIG. 3f) by 180 degrees, that other orientation will also result in the lower stationary position of infuser container 50 shown in FIG. 3i. Similarly, if infuser container 50 shown in FIG. 3h is rotated about central longitudinal axis CLA (FIG. 3f) by 180 degrees, that other orientation will also result in the higher stationary position of infuser container 50 shown in FIG. 3j.

Therefore, according to the first embodiment, one of the first plurality of orientations (causing placing the infuser container in a lower stationary position) is transformed into one of the second plurality of orientations (causing placing the infuser container in a higher stationary position) by rotating said infuser container about a central longitudinal axis of the infuser container; and
the outside perimeter of at least a section of the infuser container has dimensions, which are smaller than some of the dimensions of the inside perimeter of the beverage container but larger than some other dimensions of the inside perimeter of the beverage container; and
in each of the first plurality of orientations each dimension of the outside perimeter of said insert section is aligned with a larger dimension of the inside perimeter of the beverage container, so that the outside perimeter of the insert section is completely within the inside perimeter of the beverage container; and
in each of the second plurality of orientations at least one dimension of the outside perimeter of the insert section is aligned with a smaller dimension of the inside perimeter of the beverage container, so that parts of the outside perimeter of the insert section extend beyond the inside perimeter of the beverage container;
whereby the insert section can be inserted in the beverage container in each of the first plurality of orientations of the infuser container, but cannot be inserted in each of the second plurality of orientations; and whereby the infuser container having one out of the second plurality of orientations can be inserted in the beverage container for a shorter distance than the infuser container having one out of the first plurality of orientations.

It is appreciated that beverage containers and infuser containers according to the present invention preferably have symmetrical shapes. Therefore, an infuser container may typically have several spatial orientations, all of which result in the infuser insert being placed in the lower stationary position. Similarly, an infuser container may typically have several spatial orientations, all of which result in the infuser insert being placed in the higher stationary position. For generality, different spatial orientations of an infuser container resulting in placing the infuser container in the lower stationary position will be thereafter referred to as “the first plurality of orientations”. Different spatial orientations of an infuser container resulting in placing the infuser container in the higher stationary position will be thereafter referred to as “the second plurality of orientations”.

In some cases, when a beverage container, an infuser container, or both, have an irregular asymmetric shape, there may be only one spatial orientation, rather than a plurality of orientations, corresponding to the lower stationary position, or only one spatial orientation, rather than a plurality of orientations, corresponding the higher stationary position. Such cases are also covered by the present invention. Therefore, “a plurality of spatial orientations” in the context of the present invention may be understood as “at least one spatial orientation, and preferably several spatial orientations”.

### First Embodiment—Operation

One method of using devices (or apparatuses) according to the first embodiment comprises the following method steps:

placing the infuser container in one of a first plurality of orientations, in which orientations the outside perimeter of infuser container 50 is completely contained within the inside perimeter of section 48;
inserting infuser container 50 in beverage container 40 until infuser container 50 assumes a lower stationary position;
placing infusible material, such as tea-leaves, to infuser container 50;
pouring a liquid, such as hot water, to infuser container 50 until the liquid at least partly covers the infusible material; in both containers the liquid reaches the same level;
waiting for a first desired length of time;
lifting infuser container 50 and placing infuser container 50 in one of a second plurality of orientations, in which orientations the outside perimeter of infuser container 50 is completely contained within the inside perimeter of section 47 but not completely contained within the inside perimeter of section 48;
inserting infuser container 50 in beverage container 40 until infuser container 50 assumes a higher stationary position, in which position is inserted in section 47, but not in section 48, of beverage container 40, and in which bottom 53 of infuser container 50 is supported by ledges 43;
waiting for a second desired length of time while liquid from infuser container 50 drips to beverage container 40;
when the dripping stops or is sufficiently reduced, removing infuser container 50 from beverage container 40;
whereby a ready to use beverage, contained in beverage container 40, is prepared without excessive dripping of infusible material after the material, contained in infuser container 50, is removed from beverage container 40.

An obvious modification of the method described above is placing infuser container 50 in beverage container 40, with the infusible material being already contained in container 50. Other modifications are also obvious to those skilled in the art. In all cases the liquid, infuser container, and infusible material are all placed in the beverage container, so that the infusible material, contained inside the infuser container, is immersed in the liquid. After infusing the material for a desired length of time, the user removes the infuser container with the user material inside. The beverage container now only contains a newly prepared, ready to use beverage.

### First Embodiment—Advantages and Ramifications (FIG. 3-FIG. 11)

Devices, according to the first embodiment, have a number of advantages over prior art. While they provide a solution to the prolonged dripping problem, they are also simple, safe, an effective to use, as well as easy to learn, clean, and manufacture. They are essentially self-explanatory and the user does not need to learn how to use them. Operating such a device is quick and easy: the user simply grasps the infuser container and moves it down to insert it in the beverage container. The user also directly lifts the infuser container up to remove it from the beverage container. Little or no effort is needed to assemble or re-assemble the device. The devices are easy to clean. The user may simply remove the infuser container from the beverage container, place the infuser container over a trashcan, turn the infuser container upside down, and shake it to dispose of the used infusible materials. The parts comprising the devices have a rigid structure and may be implemented without moving elements, which makes it possible to produce such devices of only hard non-toxic materials, such as glass, porcelain, or metal. The device makes it easy to infuse the same infusible material several times, which is common when making tea according to the Chinese tradition. The device may provide ample space for the infusible material to float during the infusion process, which is known to positively affect the quality of some of the beverages made by infusion.

It is appreciated that the embodiment shown in FIG. 3 serves as an illustration of a more general subject matter, that is, adapting an infuser container and a beverage container so that the infuser container having some rotational orientations about its longitudinal axis (corresponding to a first plurality of orientations) is permitted to be inserted in a section of the beverage container, and the infuser container having some other rotational orientations about its longitudinal axis (corresponding to a second plurality of orientations) is not permitted to be inserted in said section of the beverage container. Various other modifications are obvious to the one skilled in the art and are covered by the present invention.

FIG. 3 shows a lower stationary position of insert container 50 (FIG. 3i), in which position infuser container 50 cannot be inserted more into beverage container 40 because a dimension of a top part of container 50 (namely, flange 52) exceeds a dimension of opening 51. Other ways of configuring a beverage container and an infuser container to provide stationary support for infuser container in the lower stationary position are obvious and are covered by the present invention. For instance, FIG. 4 shows infuser container 62 long enough to reach bottom 63 or narrowed lower part 65 of beverage container 61, and assume a stationary position, in which bottom 64 of infuser container 62 rests on bottom 63 or narrowed lower part 65 of beverage container 61, while the top of infuser container 62 is elevated above beverage container 61.

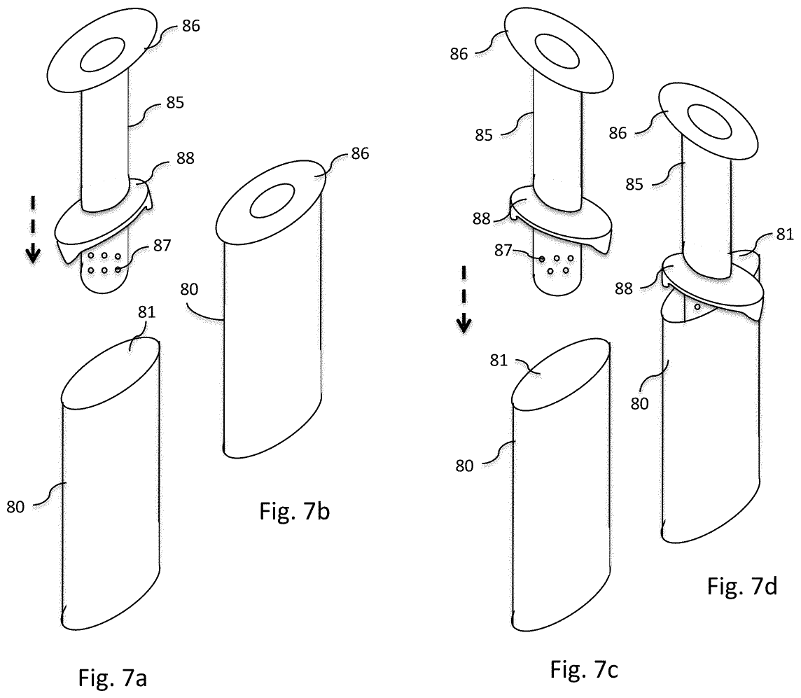

The inner contour of a top opening of a beverage container, can be defined by not only two ellipses intersected at their center points at 90 degrees, as shown in FIG. 3. The opening contour may, for instance, be defined by two ellipses intersected at various angles and at various points. FIG. 5 shows a top view of a beverage container according to the present invention, where two identical ellipses are orthogonally intersecting at a focus, instead of a center point, of one of the ellipses, to define beverage container opening 67, as well as recesses 68 forming ledges 69.

A device according to the present invention may employ various shapes other than the elliptical shape described in FIG. 3. A wide variety of two concentric shapes may be employed so that in some rotational orientations of an inner shape said inner shape is completely within the perimeter of an outer shape, while in some other rotational orientations of an inner shape said inner shape is extends beyond the perimeter of the outer shape. It is obvious that the beverage container and the infuser container may be configured so that such concentric shapes are employed as (a) an inside perimeter of a horizontal cross-section of a section of a beverage container (the larger shape) and (b) an outside perimeter of at least a part of an infuser container (the smaller shape).

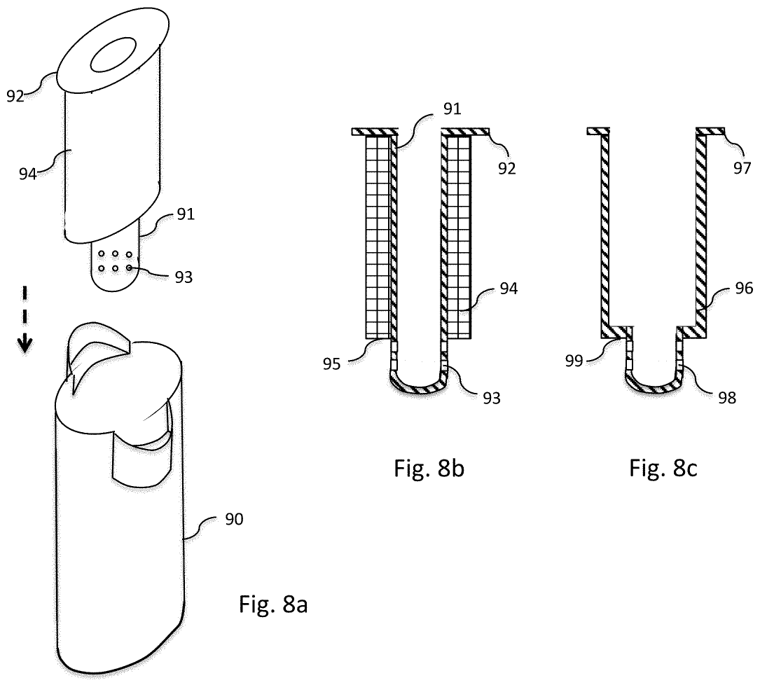

For instance, generally triangular or rectangular shapes, or diverse irregular shapes may be employed. FIG. 6 shows an example of a device employing a generally triangular shape with rounded corners for both a section of beverage container 70 (a larger shape) and infuser container 75 (a smaller shape). When infuser container 75 is rotated along a central longitudinal axis to have one of the first plurality of orientations, so that the sides of the concentric triangles are parallel to each other, infuser container 75 may be inserted in beverage container 70 to assume a lower stationary position. When infuser container 75 is rotated about the central vertical axis at 60, 180, 300, etc., degrees from said one out of the first plurality of orientations, infuser container 75 is placed in one out of the second plurality of orientations, in which orientation it may be inserted in recesses 72. When received within recesses 72, infuser container 75 rests on ledges 73 formed by recesses 72, assuming a higher stationary position.

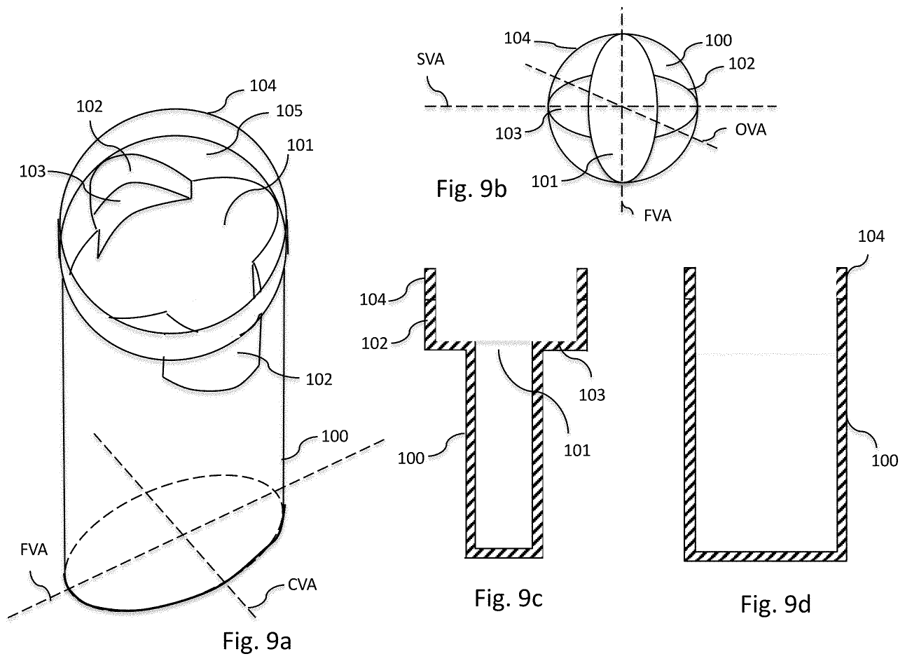

FIG. 7 shows a further modification of the first embodiment. A device according to the modification comprises infuser container 85, which may be inserted in beverage container 80 through opening 81. Infuser container 85 comprises side protrusions 88 attached to container 85's lower part, and has perforation holes 87, located below side protrusions 88. Both the inside perimeter of beverage container 80 and the outside perimeter of side protrusions 88 have generally elliptical shapes in the horizontal cross cut.

The length of major axis of beverage container 80 is greater than the length of major axis of protrusions 88, and the length of minor axis of beverage container 80 is greater than the length of minor axis of protrusions 88. Consequently, when infuser container 85 is rotated about a vertical axis so that beverage container's major axis is aligned with of protrusions 88's major axis, and beverage container's minor axis is aligned with protrusions 88's minor axis (FIG. 7a), infuser container 85 may be inserted into beverage container 80 to assume a lower stationary position (FIG. 7b). When infuser container 85 is in the lower stationary position, flange 86 of infuser container 85 rests on the rim of beverage container 80 (FIG. 7b), and the whole device assumes a stationary, substantially stable position.

The major axis of the outside perimeter of side protrusions 88 is larger than the minor axis of the inside perimeter of beverage container 80. Consequently, when infuser container 85 is rotated about a longitudinal axis so that major axis of protrusions 88 is aligned with beverage container's minor axis, infuser container 80 cannot be completely inserted to beverage container 80 (FIG. 7b). Instead, when infuser container 85, in this orientation, is moved down to beverage container 80, protrusions 88 receive resistance from the rim of beverage container 80, which rim provides support for protrusions 88. Infuser container 85 assumes a higher stationary position, in which position container 85 rests on beverage container 80 being only partly inserted in beverage container 80, and the whole device assumes a stationary, substantially stable position (FIG. 7d).

It is acknowledged that the infuser container shown in FIG. 7 can be adapted to be used in conjunction with a recess-comprising beverage container, similar to the beverage container depicted in FIG. 3.

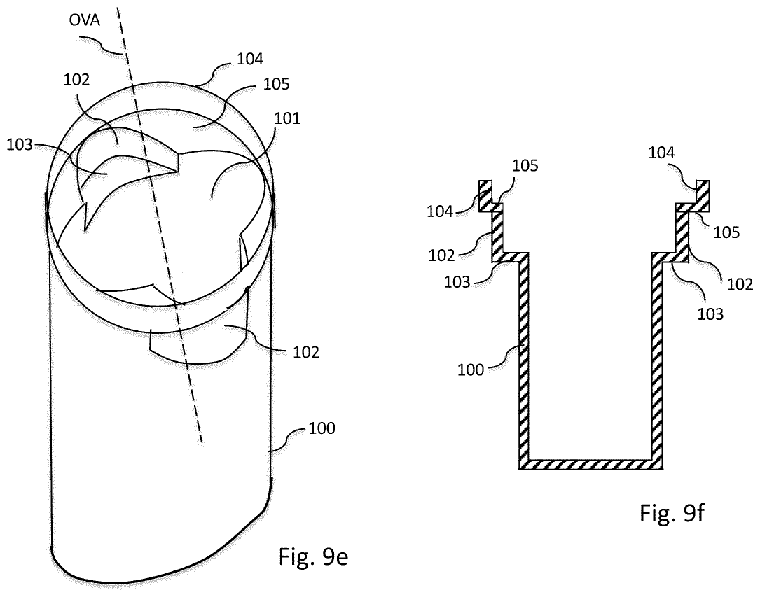

Variations of the first embodiment employing an infuser container similar to the protrusions-comprising infuser container described in FIG. 7, is shown in FIG. 8. According to the variation, an infuser container comprises an infuser container encased in a sleeve, which sleeve defines the outside horizontal perimeter of the top part of the insertion member.

FIG. 8a and FIG. 8b show an infuser container comprising a substantially cylindrical infuser container 91 with higher flange 92 and perforation holes 93, container 92 being encased in sleeve 94. The outside perimeter of sleeve 96 has an elliptical shape in a horizontal cross cut. The bottom part of sleeve 94 forms low flange 95. The infuser container shown in FIG. 8a and FIG. 8b may be used in conjunction with recess-comprising beverage container 90, similar to the beverage container 40 depicted in FIG. 3, as well as in conjunction with a no-recess beverage container, similar to the beverage container 80 depicted in FIG. 7.

FIG. 8 and FIG. 8b shows an example of using a sleeve, in which an infuser container is encased, to achieve a desired shape of the infuser container instead of changing the shape of the infuser container. Various other shapes of encased containers and sleeves may be employed in conjunctions with beverage containers of various shapes. It is appreciated that an alternative to using a sleeve for providing an infuser container of a shape illustrated by FIG. 8a and FIG. 8b is configuring the shape of an infuser container itself. FIG. 8c shows an infuser container comprising infuser container 96 having high flange 97 and perforation holes 98. Low flange 99, similar in its shape and purpose of use to low flange 95 shown in FIG. 8b, if formed by the shape of infuser container 96.

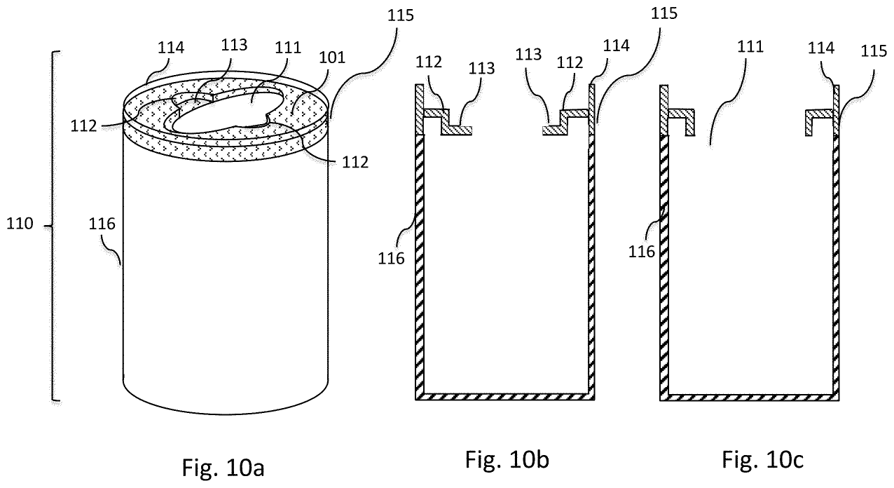

The device shown in FIG. 9 is a variation of the first embodiment depicted in FIG. 3. FIG. 9 shows beverage container 100, which comprises elevated circumferential watertight wall 104 surrounding opening 101, as well as horizontal watertight surface 105. Surface 105, consisting of four parts, fills spaces defined by opening 101, recesses 102, and wall 104. When lifted from liquid, infuser container is likely to drip, so wall 104 and surface 105 make sure the dripping liquid is not spilled outside beverage container 100. A combination of wall 104 and surface 105 provides means for preventing leakage and spilling of liquid outside beverage container 100 when the user moves the infuser container from a lower stationary position to a higher stationary position. Leakage-preventing means comprising wall 104 and surface 105 make it possible for the user to lift an infuser container from a lower stationary position (in which the infusible material is immersed in liquid) and place it in a higher stationary position (in which the infusible material is located above the liquid), while continuously keeping the infuser container partly inserted in beverage container 100. A top view of beverage container 100 shows a circle encircling opening 101, recesses 102, and ledges 103 (FIG. 9b). FIG. 9c and FIG. 9d show, respectively, a front cross section view (a vertical cross-cut defined by front view axis FVA) and a side cross-section view (a vertical cross-cut defined by side view axis SVA) of beverage container 100. A diagonal cross cut of beverage container 100, defined by axis OVA (FIG. 9b, FIG. 9e), is shown in FIG. 9f.

Therefore, according to the variation of the first embodiment, depicted in FIG. 9, the beverage container comprises an elevated wall member complemented with substantially horizontal members to collectively comprise leakage-preventing means, said leakage-preventing means configured to permit changing an orientation of said infuser container from one out of said first plurality of orientations to one out of said second plurality of orientations without completely removing said infuser container from said beverage container and thereby preventing a liquid dripping from said infuser container from spilling from said beverage container.

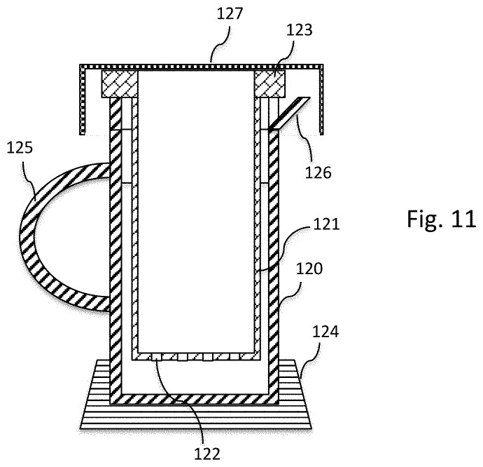

FIG. 10 shows beverage container 110 comprising cover 115 connected to cylindrical open-top receptacle 116. Employing cover 115 in combination with receptacle 116 illustrates a possibility to employ infuser containers similar to those depicted on FIG. 3, FIG. 7, and FIG. 8, having receptacles of various shapes. The shape of cover 115 is similar to the shape of the top part of beverage container 100 shown in FIG. 9. Cover 115, like the top part of beverage container 100, has elliptical opening 111, two lateral recesses 112 forming ledges 113, and leakage-preventing means comprising wall 114 and surface 101. Surface 101 fills spaces between opening 111, recesses 112, and wall 114. Cover 115 may be an integral part of beverage container 100. Alternatively, cover 115 may be a detachable part, attached to receptacle 116, for instance, as a snap-on or a twist-on attachment. Cover 115 may be removed from receptacle 116 (e.g., by twisting off), for instance, for an easy cleaning of receptacle 116.

Various modifications of the embodiment shown in FIG. 10 are obvious to those skilled in the art. They include using covers and covers' parts of different sizes and shapes. Recesses, similar to recesses 112, can be of different sizes and shapes, and adapted to support either a bottom of an infuser container, or side protrusions similar to those shown in FIG. 7 and FIG. 8. The covers can be attached to receptacles of different shapes and sizes. Various ways of attaching a cover to a receptacle may be employed. All these modifications are covered by the present invention.

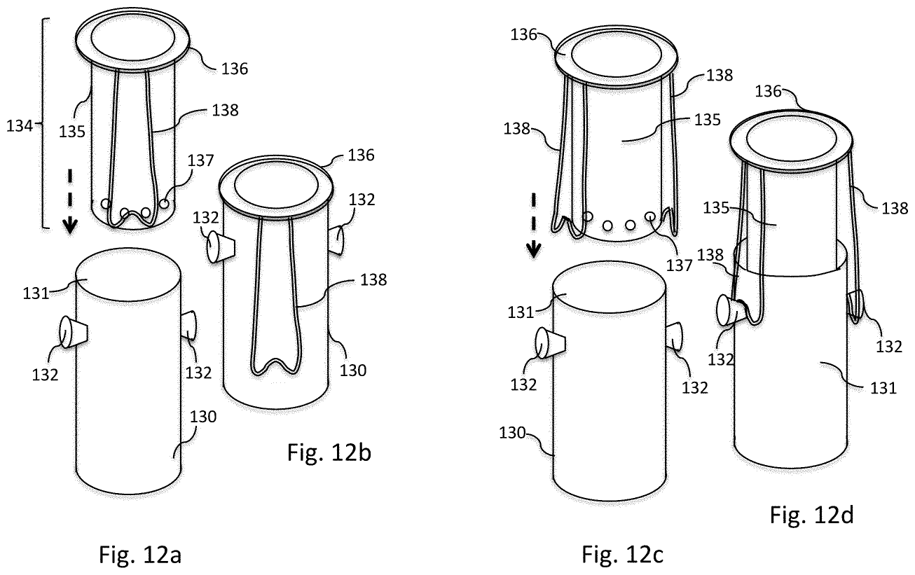

It is appreciated that a beverage-making device according to the present invention, either the entire device or its component parts, can be made of various materials, such as glass, metal, plastic, and so forth. As illustrated by FIG. 11, various additional elements can be added, such as lid 127, which can also be used as a tray for an infuser container when the infuser container is removed from a beverage container. Other elements, such as handle 125, nozzles 126, support 122, or other types of lids, nozzles, handles, and supported, can also be used. The rims of openings of both cover 115 and infuser container can be reinforced, for instance, by providing a metal brim.

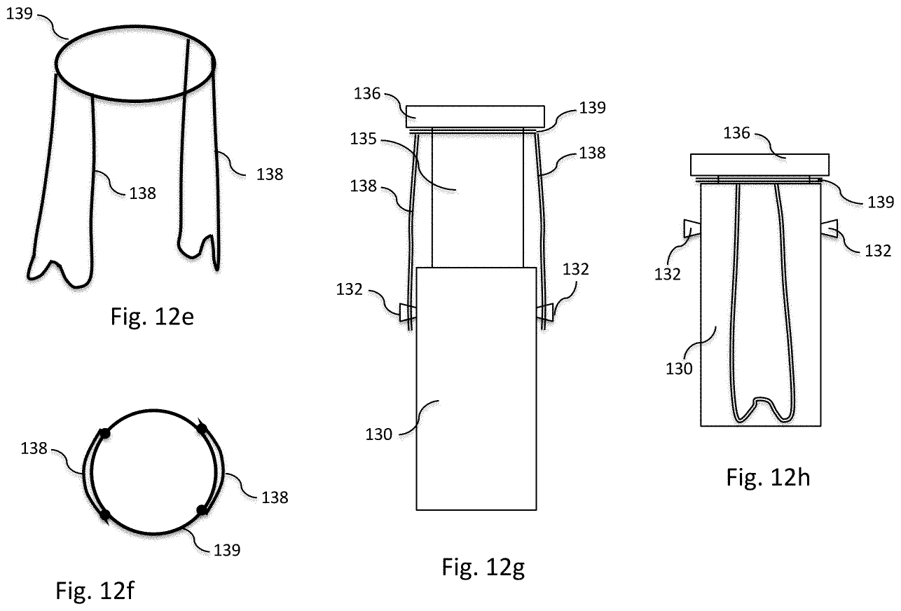

### Second Embodiment—Description and Operation (FIG. 12)

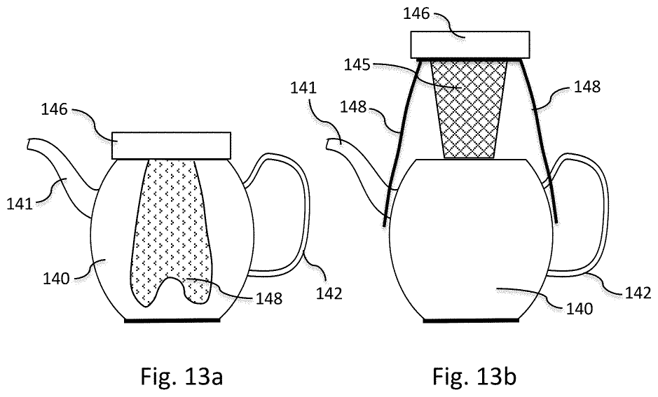

The second embodiment of the invention is shown in FIG. 12 and FIG. 13.

According to the second embodiment a transition from one of the first plurality of orientations, in which an infuser container is placed in a lower stationary position relative to a beverage container, to one of the second plurality of orientations, in which an infuser container is placed in a higher stationary position, is achieved by rotating the infuser container relative to the beverage container about a central longitudinal axis of the infuser container. The infuser container according to the second embodiment, comprises a plurality of extension members connected to the infuser container and extending substantially downwards from a top part of the infuser container along external walls of the beverage container.

External walls of the beverage container comprise a plurality of external protruding elements, which plurality of protruding elements generally match the plurality of extension members. Placing a vertically oriented infuser container above the top opening of the beverage container and rotating the infuser container about a central longitudinal axis so that the infuser container assumes one out of the first plurality of orientations places the plurality of extension members in a position, in which the extension members may move down unobstructed when the infuser container is lowered. In this orientation lowering the infuser container places the infuser container in the lower stationary position, in which a receptacle part of the infuser container containing an infusible material is located inside the beverage container, and the extension members are located outside the beverage container. Thereby infuser container assumes a lower stationary position, in which position the infuser container is supported by the beverage container, and in which position the extension members do not meet resistance from the matching protrusion elements.

Rotating a vertically oriented infuser container about a central longitudinal axis so that it assumes one of the second plurality of orientations places the extension members in a position, from which the extension members may not move down unobstructed when the infuser container is lowered. The extension members contact the protruding elements, meet resistance from the protruding elements, and receive support from the external protruding elements, which prevents the infuser container from moving lower. The infuser container assumes a higher stationary position, in which position the infuser container rests of the beverage container and the extension members press against the protruding elements.

A device according to the second embodiment is depicted in FIG. 12 and FIG. 13. The device comprises beverage container 130 and infuser container 134. Beverage container 130, having a substantially cylindrical shape, comprises top opening 131 and two external protrusions 132. External protrusions 132 are located at opposite sides of beverage container 130, protruding externally from external walls of beverage container 130. Protrusions 132 may be used as handles for operating beverage container 130. Infuser container 134 comprises substantially cylindrically shaped receptacle 135 containing the infusible material (not shown), flange 136, ring member 139 located underneath flange 136, and two extension members 138 connected to ring member 139. Receptacle 135 has perforation holes 137. Extension members 138, attached to ring member 139, extend outside receptacle 135 and beyond external walls of beverage container 130, substantially downwards. A smaller diameter of receptacle 135 compared to the diameter of beverage container 130 permits an insertion of receptacle 135 in beverage container 130 at all rotational orientations of infuser container 134 about a central longitudinal axis of container 134, since the outside perimeter of receptacle 135 is at all rotation angles is smaller than the inside perimeter of beverage container 130.

By adjusting a rotation angle of infuser container 134 about a central longitudinal vertical axis of infuser container 134 before placing infuser container 134 on beverage container 130, the user can selectively insert infuser container 134 deeper or less deep in beverage container 130, causing container 134 to assume, respectively, a lower stationary position or a higher stationary position. To choose the lower stationary position the user places infuser container 134 in upright position above opening 131 of beverage container 130 and rotates infuser container 134 so that extensions 138 are not vertically aligned with protrusions 138. When infuser container 134 in this orientation is moved down to beverage container 130, extensions 138 move down unobstructed, which permits a deeper insertion of infuser container 134 into beverage container 130. Infuser container 134 then assumes a lower stationary position (FIG. 12a, FIG. 12b, and FIG. 12h). To choose a higher stationary position the user places infuser container 134 in upright position above opening 131 of beverage container 130 and rotates infuser container 134 so that extensions 138 are vertically aligned with matching protrusions 132. When infuser container 134 in this orientation is moved down to beverage container 130, extensions 138 press against protrusions 132 and meet resistance from protrusions 132, which causes infuser container 134 stop moving further down into beverage container 130. Infuser container 134 assumes an elevated, higher stationary position, being only partly inserted in beverage container 130 (FIG. 12c, FIG. 12d, and FIG. 12g).

Therefore, according to the second embodiment, the first plurality of orientations is transformed into the second plurality of orientations by rotating the infuser container about a central longitudinal axis of the infuser container; and
the infuser container comprises a plurality of extension elements connected to the top part of the infuser container and extending downward outside the beverage container; and
external walls of the beverage container comprise at least a first a plurality of matching external protruding elements; and
in each of the first plurality of orientations of the infuser container the extension elements are not vertically aligned with the first plurality of matching protruding elements, and when the infuser container is being inserted in the beverage container the extension elements can move down unobstructed; and
in each of the second plurality of orientations of the infuser container the extension elements are vertically aligned with the first plurality of matching protruding elements, and, when the infuser container is being inserted in the beverage container, the extension elements press against said protrusion elements and meet resistance;
whereby the infuser container having one out of the second plurality of orientations can be inserted in the beverage container for a shorter distance than the infuser container having one out of the first plurality of orientations.

### Second Embodiment—Ramifications (FIG. 12, FIG. 13)

The second embodiment has substantially the same advantages as the first embodiment. The embodiment illustrated by FIG. 12 is intended as an illustrative example. Numerous modifications of beverage making devices employing external extensions of immersible infusers combined with external protrusions of beverage containers are obvious to those skilled in the art. One such modification is a device comprising an infuser container, which is implemented so that the two main parts comprising the infuser container, a receptacle for infuser material and extension members, may move independently of each other. In particular, the extension members may be able to rotate about the central longitudinal axis of the infuser container while the receptacle may maintain the same rotational orientation.

Another obvious modification is a device according to the second embodiment, comprising an additional second plurality of protruding elements supporting the infuser container in a lower stationary position. The second plurality of protrusions may be located lower than protrusions supporting the infuser container in the higher stationary position (such as protrusions 132 shown in FIG. 12).

A beverage container may have the shape of a typical teapot, with a nozzle and a handle, and said nozzle and handle may serve as external protrusions supporting the infuser container, through external extensions connected to the infuser container, in an elevated higher stationary position (FIG. 13).

The infuser container may be configured to permit rotating the plurality of extension members independently from the rest of the infuser container. For instance, ring 139 with attached extension members 138, shown in FIG. 12 may be adapted to be capable of rotating under independently of receptacle 135, so that the user may change the orientation of infuser container from one of a first plurality of orientations to one of a second plurality of orientations without rotating receptacle 135.

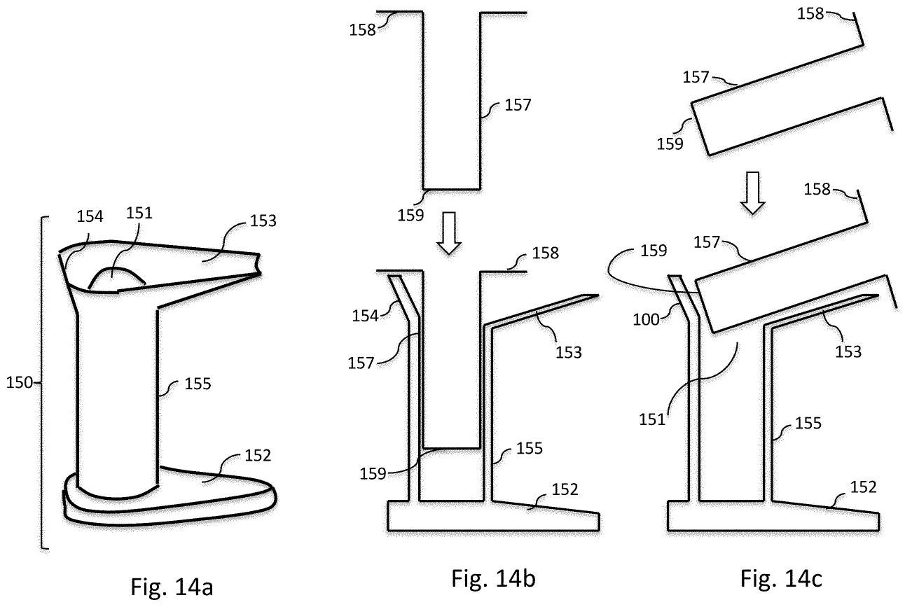

### Third Embodiment—Description and Operation (FIG. 14-FIG. 17)

A beverage container and an infuser container according to the third embodiment are configured to permit a vertically oriented infuser container to be inserted in the beverage container to assume a lower stationary position, whereas providing means to support the infuser container having a tilted position in an elevated higher stationary position. A multiplicity of means for supporting the infuser container in a tilted elevated second higher position include (a) a concave supporting member extending from a top part of the beverage container, which concave member serves as a support for the tilted infuser container and may also serve as a nozzle, (b) a part of the wall of the beverage container substantially opposite to the concave support member, which part is adapted, preferably flattened, to receive and support the bottom of the infuser container, and (c) a flange extending from a top part of the infuser container, which flange may press against the concave support member to prevent the infuser container from sliding lower relative to the beverage container, (d) protrusions from a bottom or a low part of the infuser container, which protrusions are adapted to extend above a rim of a top opening of the beverage container, and rest upon said rim of the beverage container, to support the infuser container in an elevated lilted higher stationary position.

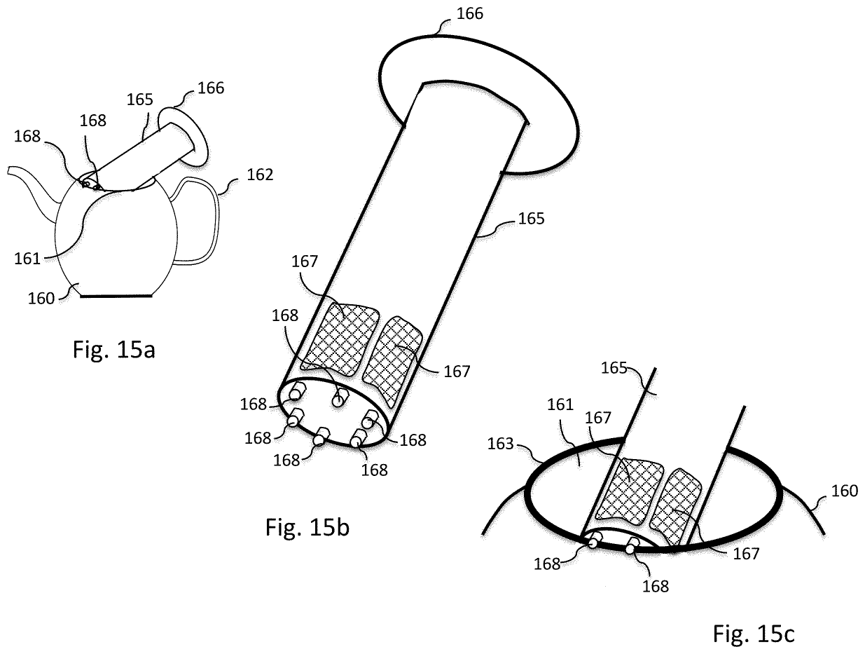

Support means according to the third embodiment are illustrated by FIG. 14-FIG. 15. A device shown in FIG. 14 comprises an infuser container 157 and a beverage container 150. Infuser container 157 is an open top container made of glass and having a substantially cylindrical shape, comprising bottom 159 and flange 158, which flange is extending from a top part of infuser container 157. A plurality of holes around bottom 159 is provided (not shown). Beverage container 150 comprises three integrated sections: lower section 152 configured as a support member for increased stability of the device, substantially cylindrical middle section 155 providing space for containing liquid, section 152 housing infuser container 157 in the lower stationary position, and a top section, which top section comprises a multitude of means for supporting infuser container 157 in a tilted higher stationary position. In the higher stationary position infuser container 157 is tilted as a certain angle (that is, rotated so that its central longitudinal axis is oriented at an angle to a vertical axis). The multitude of supporting members includes the following means: an extended preferably concave member 153, which forms a slide for supporting infuser container 157 and can also serve as a nozzle, flattened wall area 154 located at substantially the same level as concave member 153 on the opposite side of inside perimeter 151 of beverage container 150, and flange 158. When infuser container 157 is in the higher stationary position, flange 158 presses against concave member 153 to prevent infuser container 157 from sliding lower relative to beverage container 150.

When using the device shown in FIG. 14, the user first places a vertically oriented infuser container 157, infusible material (not shown) contained in infuser container 157, and liquid (not shown) in beverage container 150. Infuser container 157 assumes a lower stationary position and the infusible material is at least partly covered by the liquid. The user allows the infusible material to be infused in the liquid for a desired length of time, and then lifts up infuser container 157, tilts container 157, and places container 157 at a top part of beverage container 150, so that container 157 is supported in a tilted position by one or several supporting means. selected from a group comprising by concave member 153, wall area 154, and flange 158. The liquid dripping from container 157 flows to beverage container 150. After a desired length of time, when the dripping ends or is sufficiently reduced, the user removes container 157 with the used infusible material, and uses the newly prepared beverage contained in beverage container 150.

An additional support means according to the third embodiment is illustrated by FIG. 15. FIG. 15 shows a variation of a beverage-making device according to the third embodiment. FIG. 15 shows beverage container 160 having top opening 161 and handle 162. Infuser container 165 is implemented as an open-top metal cylinder. Parts 167 of infuser container 165 are made of metal mesh. Flange 166 extends from the top opening of container 165. Container 165 has six bottom protrusions 168. Protrusions 168 are adapted to keep container 165 in a stationary upright position when container 165 is placed on a horizontal surface. When container 165 is vertically inserted in opening 161, container 165 assumes the higher stationary position (not shown), similar to the higher stationary position depicted, for instance, in FIG. 4. When container 165 is partly removed from beverage container 160 and tilted by manually placing container 165 at an angle to the vertical axis, some of protrusions 168 extend beyond rim 163 of opening 161, press against rim 163, and in conjunction with a part of rim 163, which part is substantially opposite to the part of rim 163 contacted by protrusions 168, provide a support means for supporting infuser container 165 in the tilted position. The support means ensure a stable elevated tilted second higher stationary position of infuser container 165 sitting on beverage container 160.

To use the device shown in FIG. 15 the user first places in beverage container 160 the following: vertically oriented infuser container 165, infusible material (not shown) contained in infuser container 165, and liquid (not shown). Infuser container 165 assumes a lower stationary position and the infusible material is at least partly covered by the liquid. The user allows the infusible material to be infused in the liquid for a desired length of time, and then lifts up infuser container 165, tilts container 165, and places container 165 at a top part of beverage container 160, so that container 165 is supported in a tilted position by at least one protrusion 168 and the rim of opening 161. Infuser container 165 is placed so that at least one protrusion 168 extends from bottom of infuser container 165 beyond the rim of opening 161 and rests on the rim of opening 161, preventing infuser container 165 from slipping into opening 161. The liquid dripping from container 165 flows to beverage container 160. After a desired length of time, when the dripping ends or is sufficiently reduced, the user removes container 165 with the used infusible material from beverage container 160, and uses the newly prepared beverage contained in beverage container 160.

Therefore, according to the third embodiment the first plurality of orientations is transformed into the second plurality of orientations by tilting the infuser container, that is, rotating the infuser container about a horizontal axis orthogonal to the central longitudinal axis of the infuser container; and the beverage container and the infuser container are configured so that the infuser container may assume a tilted elevated higher stationary position, in which position the infuser container sits/rests on the beverage container and is supported by said beverage container, and a plurality of supporting means is provided to support the infuser container in a tilted elevated higher stationary position.

### Third Embodiment—Ramification (FIG. 14-FIG. 17)

The support means described in FIG. 14 and FIG. 15 can be used in various combinations. For instance, a concave support member, similar to support member 153 shown in FIG. 14, can be used in combination with bottom protrusions, similar to protrusions 168 shown in FIG. 15.

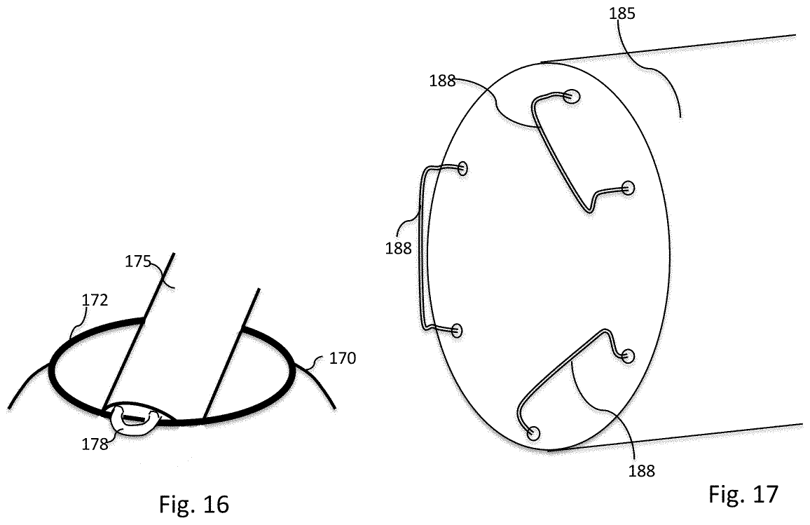

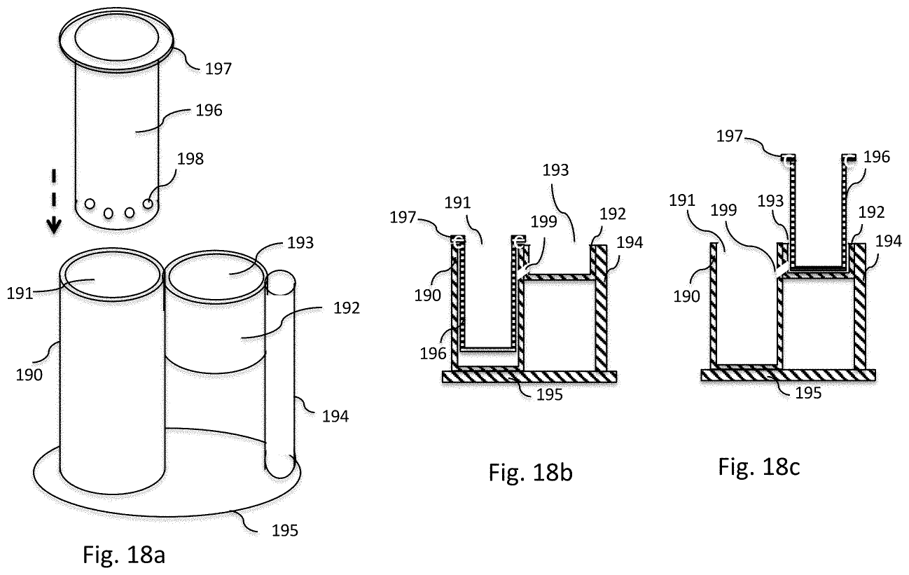

Various shapes of bottom protrusions holding an infuser container in a tilted position, partly immersed in a beverage container, can be employed. For instance, FIG. 16 and FIG. 17 show bottom protrusions implemented as braces, either straight braces 178 (FIG. 16) or bent braces 188 (FIG. 17), which braces are bent inward to serve as hooks and provide better engagement with the rim of the opening of the beverage container, and also for achieving a more stable upright position on a horizontal surface. It is appreciated that bottom protrusions according to the fourth embodiment can have various other shapes and may not be directly attached to the bottom of the infuser container, but rather generally connected to a lower part of the infuser container.

In addition, various means, described in the context, can be used to support the infuser container in the lower stationary position. For instance, in the lower stationary position a top flange of an infuser container may rest on the rim of a top opening of a beverage container; or an infuser container can be long enough to be inserted into a beverage container for the full height of the beverage container, so that the bottom of the infuser container rests on the bottom of the beverage container.

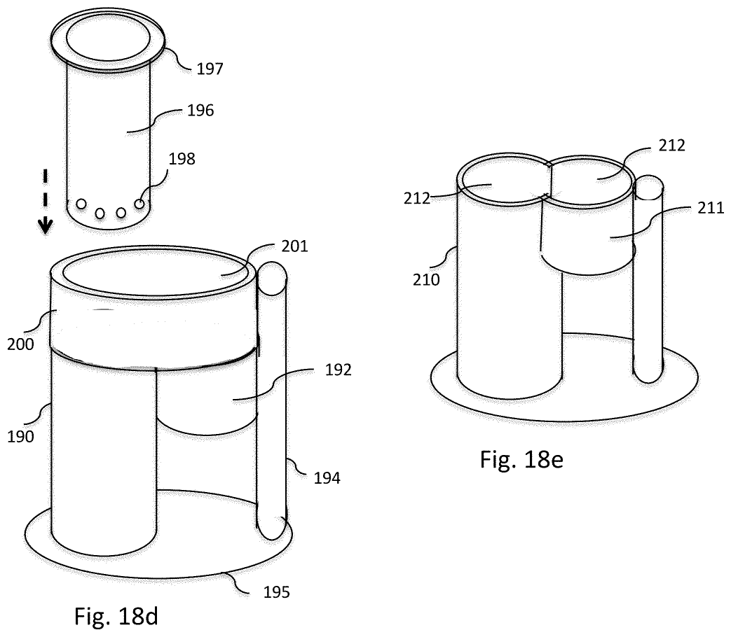

### Fourth Embodiment—Description, Operation, and Ramification (FIG. 18)

According to the fourth embodiment of the invention, one of the first plurality of orientations is transformed into one of the second plurality of orientations by horizontally moving the infuser container, the infuser container being in the upright position, relative to the beverage container. The apparatus comprises, in addition to a beverage container, a separate secondary vertically oriented open-top section. The secondary section has a bottom, which is located higher than the bottom of the beverage container. The secondary section is connected to the main beverage container to allow liquid from the secondary section to flow to the beverage container. The secondary section and the insert container are configured to permit an insertion of the infuser container through an opening at the top part of the secondary section. In the first plurality of orientations, when the infuser container is vertically aligned with the opening of the beverage container, the infuser container can be inserted in the beverage container to assume the lower stationary position. In the second plurality of orientations the infuser container is vertically aligned with the top opening of the secondary section and, when inserted in the secondary section, assumes the second higher stationary position.

A beverage-making device according to the fourth embodiment, is shown in FIG. 18. FIG. 18a shows beverage container 190 having top opening 191 and secondary section 191 having top opening 192. Vertical support 194 and horizontal support 195 are provided to ensure stability of the device. Infuser container 196 is implemented as an open-top cylinder comprising perforation holes 198. Flange 197 extends from the top opening of infuser container 196.

Through-channel 199 connects secondary section 192 and beverage container 190, so that liquid from secondary section 192 may flow to beverage container 190 via channel 199.

Therefore, according to the fourth embodiment the beverage container and the infuser container are configured to permit a transition from one of a first plurality of orientations to one of the second plurality of orientations by horizontally moving the infuser container relative to the beverage container; and
the apparatus additionally comprises a secondary vertically oriented open-top section, said secondary section having a bottom positioned higher than the bottom of the beverage container; and
the secondary section being connected to the main beverage container to allow liquid from the secondary section to flow to the beverage container; and
the secondary section and the insert container are configured to permit an insertion of the insert container through an opening at the top part of the secondary section;
whereby in the first plurality of orientations, when the infuser container is vertically aligned with the opening of the beverage container, the infuser container can be inserted in the beverage container to assume the lower stationary position, and in the second plurality of orientations, when the infuser container is vertically aligned with the top opening of the secondary section, the infuser container can be inserted in the secondary section to assume the higher stationary position.

To use the device according to the fourth embodiment the user first places in beverage container 190 the following: vertically oriented infuser container 196, infusible material (not shown) contained in infuser container 196, and liquid (not shown). When inserting infuser container 196 into beverage container 190 the user places infuser container 196 in one of the first plurality of orientations. In one of the first plurality of orientations infuser container 196 is placed directly above top opening 191 of beverage container 190. When infuser container 196 is moved down to beverage container 190, container 196 is vertically inserted in container 190 and assumes the lower stationary position (FIG. 18b). The user allows the infusible material to be infused in the liquid for a desired length of time, and then lifts up infuser container 196 and places container 196 above top opening 193 of secondary section 192. When infuser container 196 is moved down to secondary section 192, container 196 is vertically inserted in secondary section 192 and assumes the second higher stationary position (FIG. 18c). The liquid dripping from container 196 flows to beverage container 190 through through-channel 199. After a desired length of time, when the dripping ends or is sufficiently reduced, the user removes container 196 with the used infusible material from the device and uses the newly prepared beverage contained in beverage container 190. Apparatuses according to the fourth embodiment can employ beverage containers, secondary sections, and infuser containers of various shapes, sizes, and materials. In addition, while FIG. 18a-FIG. 18d shows a device employing additional section 192 separated from beverage container 190 by a wall, it is obvious that there may be no wall separating a beverage container and an additional section. An additional section and a top part of a beverage container may partly overlap and comprise a combined space with a shared wall. This variation of the fourth embodiment is illustrated in FIG. 18e. FIG. 18e shows a beverage container 210 and a secondary section 211, which container and section partly overlap and form a combined space defining a common top opening 212.

### General Remarks and Ramifications

A. Apparatuses according to the present invention can be used for preparing a wide variety of beverages, using various infusible materials (including black tea, green tea, white tea, rooibos tea, hibiscus tea, herbal tea, ground coffee, herbs, dried berries, and so forth) and various liquids.
B. Apparatuses according to the present invention can have various form factors and can be implemented as various products. For instance, they may or may not be implemented as electric kettles. They can be implemented as devices for personal use (e.g., serve as personal tea cups) or group use (i.e., devices shared by several uses). They can be made of various materials, for instance, glass, metal, porcelain, clay, plastic, as well as fabrics attached to a rigid frame, or of a combination of different materials.
C. Apparatuses according to the present invention can be combined with various additional elements, such as a lid, which may, for instance, serve as tray for the infuser container when the container is removed from the beverage container.
D. The terms “apparatus and “device” are used interchangeably in this document.
E. When beverage containers of the types described in FIG. 3-18 are in use, they are normally oriented upright, so that their openings are located substantially in their upper sections, facing up, to avoid spilling the liquid contained in the beverage container. This orientation is considered “vertical” in the context of the present disclosure, and other terms, such as, “horizontal”, “higher”, “lower”, “up”, and “down” are used here in relation to this (vertical) orientation of beverage containers. The use of the terms is limited to the purpose of illustrating the described embodiments of the invention. It is understood that the containers can be oriented so that the openings face virtually any direction, in particular, when parts of a device are being cleaned, stored, or assembled before adding liquid. The use of the terms, “vertical”, “lower”, “down” and so forth, therefore, does not limit the scope of the invention.
F. There may not be a clear border separating a container's walls and bottom, for instance, if a beverage container has a substantially semi-spherical shape (in which case the beverage container my be attached to a stand having a flat lower part and a concave upper part serving as a receptacle to beverage container's bottom, to ensure stability of the beverage container). In such cases the bottom of the container is generally the part of the container, which is located opposite to the top opening and represents a lower part of the beverage container during the normal use conditions. Defining an exact border between the walls and the bottom of a beverage container is not essential for the subject matter of the present invention.
G. A longitudinal axis in the context of the present invention is an axis, which is parallel to the top-bottom dimension of an infuser container or a beverage container. If not specially mentioned, both containers are oriented so that their top openings are located above, and are vertically aligned with, their bottoms.
H. The transition from one out of the first plurality of orientations (in which orientations the infuser container assumes the lower stationary position when being lowered on the beverage container) to one out of the second plurality of orientations (in which orientations the infuser container assumes the second higher stationary position when being lowered on the beverage container), according to the first and second embodiments of the present invention, is described above as being achieved by rotating the infuser container about its central longitudinal axis. It is obvious to those skilled in the art, that additional movements may be required in addition to changing the rotational orientation of an infuser container about a longitudinal axis. For instance, the variation of the first embodiment depicted in FIG. 5 requires that the infuser container is both rotated and moved horizontally in order to be placed in the second higher position. In general, to successfully perform a transition of an infuser container from one of the first plurality of orientations to one of the second plurality of orientations according to the first and second embodiments, the user does not need to accurately identify and use the central longitudinal axis of the infuser container. Such as transition can be achieved, for instance, by rotating the infuser container about any longitudinal axis and then adjusting the position of the infuser container by moving the container horizontally.
Furthermore, it is understood that
   The above difference between the first and second pluralities of orientations is described regarding the outcome, rather than the actual process, of the transition. When moving an infuser container from one of the first plurality of orientations to one of the second plurality of orientations the user may achieve the transition in several steps and by combining various types of movements. The process may also include trial and error.
   The third and fourth embodiments of the invention, which teach the transition from one of the first plurality of orientations to one of the second plurality of orientations by tilting the infuser container, may include various rotations of the infuser container about a central longitudinal axis. Such rotations do not affect the position of the infuser container: the container remains to be in, respectively, the lower or the higher position regardless of such rotations.
When moving an infuser container from the lower stationary position to the second higher position the user may combine the transition from one of the first plurality of orientations to one of the second plurality of orientations with the movements of removing the infuser container from the beverage container and/or placing the infuser container to the beverage container. For instance, some of the necessary rotation can be performed while moving the infuser container up and/or down.

Additionally, it is understood that the scope of the present invention extends to apparatuses, which do not include a particular beverage container; such apparatuses are adapted to be used in combination with a variety of vessels serving as beverage containers. In other words, consumer products implementing the invention may not include a beverage container; instead, they allow the user himself or herself to choose a beverage container for preparing a beverage. For instance, when manufactured or sold, such products may only include an infuser container or a combination of an infuser container and a supporting base similar to cover 115 shown in FIG. 10. Such components are provided to be used in combination with a variety of vessels of the user's choosing, which vessels serve as beverage containers.

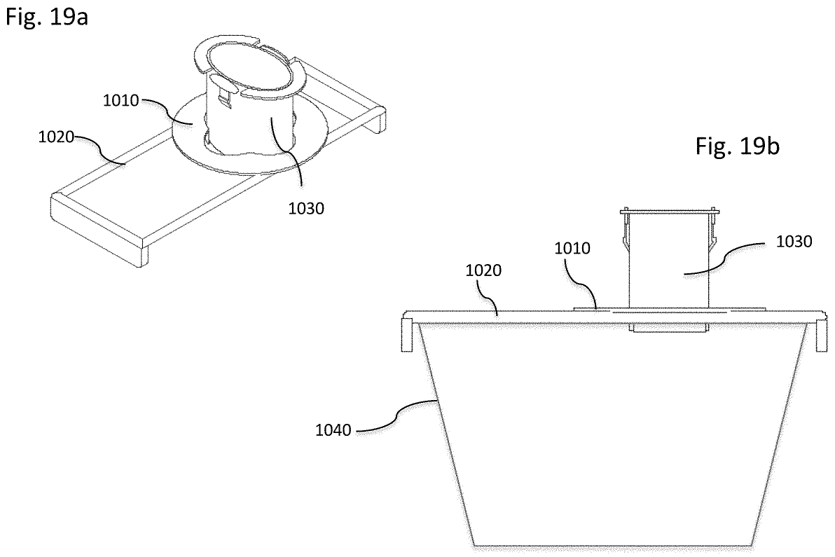

For instance, a product according to a variation of the first embodiment may comprise an infuser similar to infuser container 50 (see FIG. 3) and a supporting base similar to cover 115 (see FIG. 10). The supporting base, like cover 115, supports the infuser container in both higher stable position and lower stable position. The supporting base is adapted, using methods obvious to those skilled in the art, to allow its use in combination with a variety of containers of different shapes and sizes, such as cups, mugs, glasses, teapots, carafes, or kettles. A supporting base can have horizontal extensions, which extensions allow the supporting base to be supported by containers of various sizes and shapes in a stable position over top openings of said containers. A variation of such embodiment is illustrated in FIG. 19. It shows a supporting base being a physical object comprising two integrated components: holder 1010 and frame 1020 (FIG. 19a, b). The components are made of a hard material, such as metal, and are permanently attached (e.g., glued or soldered) to each other, or the whole supporting base can be manufactured as one physical object. Holder 1010, similarly to cover 115 (FIG. 10), supports infuser container 1030 in both lower stable position (not shown) and higher stable position. Frame 1020 makes it possible to place the supporting base over container 1040 (e.g., a cup) serving as a beverage container (FIG. 19b). In the lower stable position (not shown) of infuser container 1030, infusible material, such tea leaves, contained in infuser container 1030, is submerged in the liquid contained in beverage container 1040. In the higher stable position of infuser 1030 the infusible material is located substantially above the liquid contained in beverage container 1040.

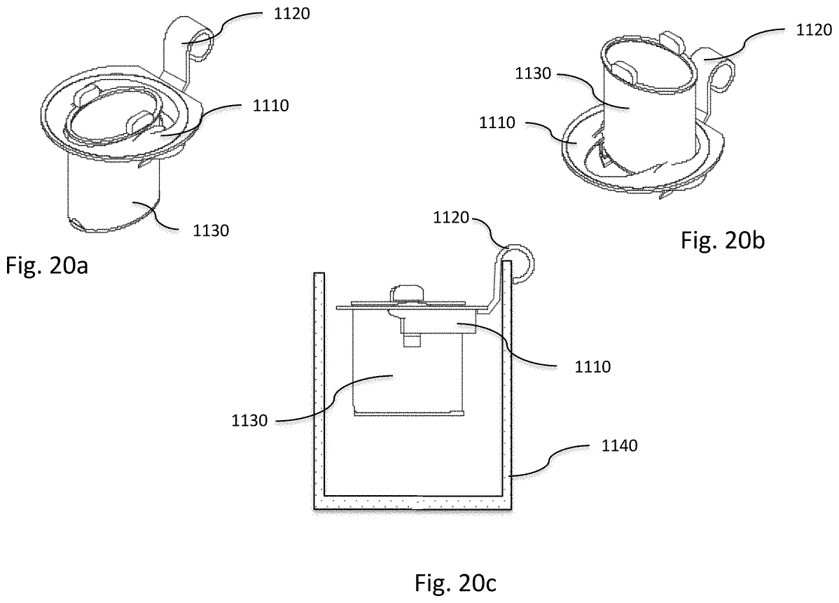

A variation of the above embodiment is shown in FIG. 20. According to the embodiment, holder 1110, which is similar to holder 1010, can support infuser container 1130 in a lower stable position and a higher stable position. Holder 1110 is integrated with handle 1120, which handle is engaged with the rim of a top opening of beverage container 1140, and thus may support holder 1110 in a stable position substantially relative to beverage container 1140.

Another embodiment of the invention (not shown) may include a supporting base similar to the ones shown in FIG. 19 and FIG. 20, but with a holder component shaped similarly to the top part of beverage container 150 shown in FIG. 14. Such holder would allow placing an infuser container in either a lower stable position (vertical) or a higher stable position (tilted). Yet another variation is a holder shaped as the top part of beverage containers 190 or 210 (FIG. 18)

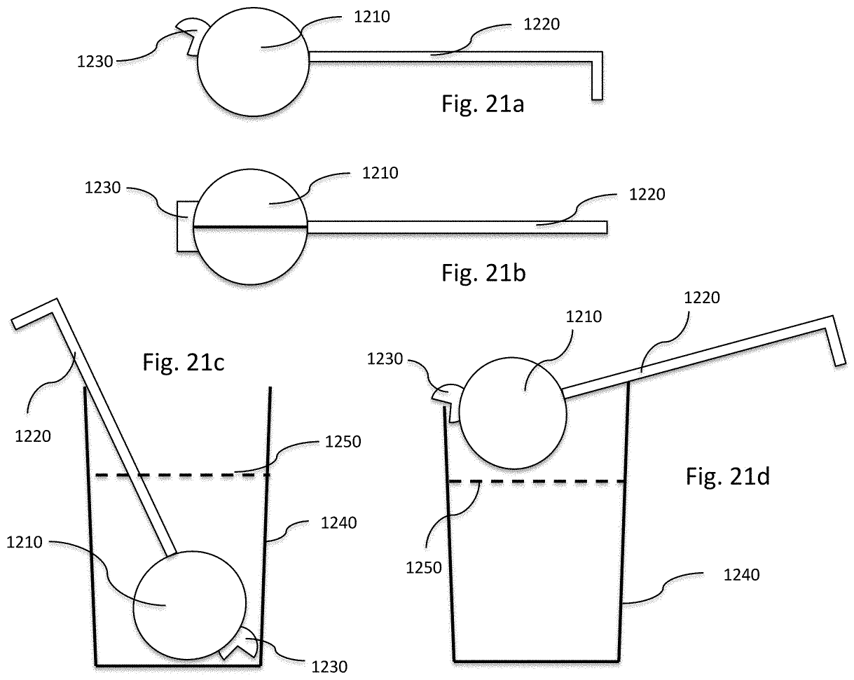

An infuser similar to infusers 165 (FIG. 15), 175 (FIG. 16), and 185 (FIG. 17), can be a separate product, used in combination with a variety of different beverage containers. Similarly, an infuser shown in FIG. 21, and comprising a spherical infuser container 1210 (two hollow hemispherical perforated containers connected to each other, for instance snapped into each other by being pressed together), a handle 1220, and a protrusion 1230, can be used with a variety of vessels, such as glasses or cups. To produce a beverage, the infuser is placed in vessel 1240 so that infuser container 1210 is located substantially below liquid level 1250. After a desired time, the infuser is moved to a different position, in which infuser container 1210 is located substantially above liquid level 1250 by being supported by handle 1220 and protrusion 1230 pressing against the top opening of vessel 1240.

All these embodiments are within the scope of the present invention.

What is claimed is:

1. An apparatus for making beverages by immersing an infusible material in a liquid, said apparatus comprising:
a substantially rigid-frame liquid-impermeable beverage container, said beverage container comprising a bottom and walls, said beverage container having an opening at a top part of said beverage container; and
a detachable infuser container having a rigid-frame body comprising a bottom and walls, wherein at least a part of said body being partly liquid-permeable, said liquid-permeable body being impermeable to said infusible material; and
wherein said beverage container and said infuser container are configured to permit said infuser container having one out of a first plurality of spatial orientations relative to said beverage container to assume a substantially stable lower stationary position when placed on said beverage container, in which lower stationary position said infuser container sits/rests on said beverage container and is being supported by said beverage container, in which lower stationary position said infuser container being is at least partly inserted in said beverage container through said top opening of said beverage container; and
wherein said beverage container and said infuser container are configured to permit said infuser container having one out of a second plurality of spatial orientations relative to said beverage container to assume a substantially stable higher stationary position when placed on said beverage container, in which higher stationary position said infuser container sits/rests on said beverage container and is being supported by said beverage container, in which higher stationary position said bottom of said infuser container and said opening of said beverage container are substantially vertically aligned with each other; and
wherein in said lower stationary position said bottom of said insert container is located lower than said bottom of said insert container is located in said higher stationary position;
whereby the user, when placing said infuser container in said beverage container, may selectively place said infuser container in said lower stationary position by selecting one out of said first plurality of orientations of said infuser container, and may selectively place said infuser container in said higher stationary position by selecting one out of said second plurality of orientations of said infuser container, wherein in said lower stationary position said infusible material may be immersed in said liquid, and in said higher position said infusible content may be elevated above said liquid.

2. Apparatus of claim 1, wherein in said first plurality of spatial orientations said top opening of said infuser container is being located above said bottom of said infuser container, and wherein said bottom of said infuser container and said opening of said beverage container are substantially vertically aligned with each other.

3. Apparatus of claim 1, wherein changing an orientation of said infuser container from one out of said first plurality of orientations to one out of said second plurality of orientations is performed by a user-action selected from a group comprising: (a) rotating said infuser container about an infuser container's central vertical longitudinal axis, (b) tilting said infuser container by rotating said infuser container about a horizontal axis, and (c) horizontally moving said vertically oriented infuser container.

4. Apparatus of claim 3, wherein
the first plurality of orientations is transformed into the second plurality of orientations by rotating said infuser container about a central longitudinal axis of the infuser container; and
the outside perimeter of at least a section of the infuser container has dimensions, which are smaller than some of the dimensions of the inside perimeter of the beverage container but larger than some other dimensions of the inside perimeter of the beverage container; and
in each of the first plurality of orientations each dimension of the outside perimeter of said insert section is aligned with a larger dimension of the inside perimeter of the beverage container, so that the outside perimeter of the insert section is completely within the inside perimeter of the beverage container; and
in each of the second plurality of orientations at least one dimension of the outside perimeter of the insert section is aligned with a smaller dimension of the inside perimeter of the beverage container, so that parts of the outside perimeter of the insert section extend beyond the inside perimeter of the beverage container; and
whereby the insert section can be inserted in the beverage container in each of the first plurality of orientations of the infuser container, but cannot be inserted in each of the second plurality of orientations; and whereby the infuser container having one out of the second plurality of orientations can be inserted in the beverage container for a shorter distance than the infuser container having one out of the first plurality of orientations.

5. Apparatus of claim 3, wherein
the first plurality of orientations is transformed into the second plurality of orientations by rotating the infuser container about a central longitudinal axis of the infuser container; and
the infuser container comprises a plurality of extension elements connected to the top part of the infuser container and extending downward outside the beverage container; and
external walls of the beverage container comprise at least a first a plurality of matching external protruding elements; and
in each of the first plurality of orientations of the infuser container the extension elements are not vertically aligned with the first plurality of matching protruding elements, and when the infuser container is being inserted in the beverage container the extension elements can move down unobstructed; and
in each of the second plurality of orientations of the infuser container the extension elements are vertically aligned with the first plurality of matching protruding elements, and, when the infuser container is being inserted in the beverage container, the extension elements press against said protrusion elements and meet resistance;
whereby the infuser container having one out of the second plurality of orientations can be inserted in the beverage container for a shorter distance than the infuser container having one out of the first plurality of orientations.

6. Apparatus of claim 5, wherein said infuser container is configured to permit an independent rotation of said infuser container and said plurality of extension elements.

7. Apparatus of claim 3, wherein
the first plurality of orientations is transformed into the second plurality of orientations by tilting the infuser container, that is, rotating the infuser container about a horizontal axis orthogonal to the central longitudinal axis of the infuser container; and
the beverage container and the infuser container are configured so that the infuser container can assume a tilted elevated higher stationary position, in which position the infuser container sits/rests on the beverage container and is supported by said beverage container.

8. Apparatus of claim 7, wherein
said beverage container comprises a preferably concave support member extending from a top part of said beverage container, said support member adapted to be capable to support said tilted infuser container in said second higher stationary position; and
wherein a shape of a part of a wall of said beverage container, which wall part is located substantially opposite said support member, is adapted to receive and support said bottom of said insert container.

9. Apparatus of claim 7, wherein said bottom of said infuser container comprises a plurality of protrusion elements configured to support said infuser container in said second higher stationary position.

10. Apparatus of claim 9, wherein said bottom protrusion elements are configured as braces, preferably bent inward, to serve as hooks and provide a better engagement with the opening of said beverage container when said infuser container is supported in said second higher stationary position.

11. Apparatus of claim 3, wherein
the beverage container and the infuser container are configured to permit a transition from one of a first plurality of orientations to one of the second plurality of orientations by horizontally moving the infuser container relative to the beverage container; and
the apparatus additionally comprises a secondary vertically oriented open-top section, said secondary section having a bottom positioned higher than the bottom of the beverage container; and
the secondary section being connected to the main beverage container to allow liquid from the secondary section to flow to the beverage container; and
the secondary section and the insert container are configured to permit an insertion of the insert container through an opening at the top part of the secondary section;
whereby in the first plurality of orientations, when the infuser container is vertically aligned with the opening of the beverage container, the infuser container can be inserted in the beverage container to assume the lower stationary position, and in the second plurality of orientations, when the infuser container is vertically aligned with the top opening of the secondary section, the infuser container can be inserted in the secondary section to assume the higher stationary position.

12. Apparatus of claim 1, wherein said beverage container additionally comprises at least an element selected from a group comprising at least: a nozzle or nozzles, a handle or handles, a reinforcing rim member attached to the top opening of the beverage container, a cover attached to the top opening of said beverage container, a stand or support, a lid or lids.

13. Apparatus of claim 1, wherein said infuser container additionally comprises at least an element selected from a group comprising at least: a nozzle or nozzles, a handle or handles, a stand or support, and a lid or lids.

14. Apparatus of claim 1, additionally comprising a lid, said lid being preferably configured to be capable of serving as a tray for said infuser container when said infuser container is detached from said beverage container.

15. Apparatus of claim 1, wherein the beverage container comprises an elevated wall member complemented with substantially horizontal members to collectively comprise leakage-preventing means, said leakage-preventing means configured to permit changing an orientation of said infuser container from one out of said first plurality of orientations to one out of said second plurality of orientations without completely removing said infuser container from said beverage container and thereby preventing a liquid dripping from said infuser container from spilling from said beverage container.

16. A method for preparing beverages using an apparatus comprising at least a rigid-frame stationary open-top liquid-impermeable beverage container and a detachable rigid-frame infuser container, said infuser container being liquid-permeable but impermeable to an infusible material used to prepare a beverage, said beverage container and said infuser container configured to permit said infuser container to be directly inserted in said beverage container through an opening at a top of said beverage container and directly removed from said beverage container through an opening at a top of said beverage container, said infuser container configured to permit said infuser container in one out of a first plurality of spatial orientations relative to said beverage container to be inserted in said opening at a top of said beverage container to assume a lower stationary position on said beverage container, said beverage container and said infuser container configured to permit said infuser container in one out of a second plurality of spatial orientations relative to said beverage container to be placed on said beverage container to assume a higher stationary position on said beverage container, in which higher stationary position a bottom of said infuser container and said top opening of said beverage container are vertically aligned with each other, and wherein in said lower stationary position said insert container is positioned lower relative to said beverage container than in said second stationary position, the method comprising method steps of
placing said infuser container in one of said first plurality of orientations;
inserting said infuser container in said beverage container until said infuser container assumes said lower stationary position;
placing an infusible material to said infuser container;
pouring a liquid to said infuser container until the liquid at least partly covers said infusible material;
waiting for a first desired length of time;
lifting said infuser container and placing said infuser container in one of said second plurality of orientations;
inserting said infuser container in said beverage container until said infuser container assumes said higher stationary position;
waiting for a second desired length of time;
removing said infuser container from said beverage container;
whereby a ready to use beverage is made, said beverage contained in said beverage container, without an excessive dripping of said infusible material after said material is removed from said beverage container.

17. Apparatus of claim 1, wherein a particular beverage container is not included; said apparatus adapted to be used in combination with a variety of existing vessels serving as beverage containers.
